(19) United States
(12) Patent Application Publication
(10) Pub. No.: US 2023/0311377 A1
(43) Pub. Date: Oct. 5, 2023

(54) FLUID DISPENSERS FOR FLUID PRODUCTS AND DISPENSING SOLUTIONS

(71) Applicant: Sealed Air Corporation (US), Charlotte, NC (US)

(72) Inventors: Kostadin I. Kostadinov, Fort Mill, SC (US); Greg L. Bard, Fort Mill, SC (US); Stoyanka D. Kostadinova, Fort Mill, SC (US); Garrett P. Dyer, Charlotte, NC (US); Rakesh Mishra, Charlotte, NC (US)

(21) Appl. No.: 17/928,637

(22) PCT Filed: Jun. 3, 2021
(86) PCT No.: PCT/US2021/035576

§ 371 Date: Nov. 30, 2022

Related U.S. Application Data
(60) Provisional application No. 63/035,013, filed on Jun. 5, 2020.

(51) Int. Cl. B29C 44/36

(52) U.S. Cl. CPC B29C 44/367; B29K 2105/04

(57) ABSTRACT

A fluid dispenser (10) includes a housing (12) and a valving rod (14). The housing includes an inlet (28) that receives a fluid product, an internal chamber (26) in fluid communication with the inlet, a discharge port (20) in fluid communication with the internal chamber that dispenses fluid from the internal chamber, a dispensing fluid inlet (38) that receives a dispensing fluid, and a dispensing fluid passage system that carries the dispensing fluid to the discharge port. The valving rod is disposed in the housing and moves within the internal chamber between an open position and a closed position. The dispensing fluid passage system includes a first passageway (44) that carries the dispensing fluid in a first direction and a second passageway (48) that carries the dispensing fluid in a second direction. The second passageway has a distal end that dispenses the dispensing fluid proximate the discharge port.

### BACKGROUND

The present disclosure is in the technical field of fluid dispensers and related apparatus used to produce on-demand foam-in-place packaging cushions. More particularly, the present disclosure is directed to an improved system for delivering dispensing solution (e.g., a reaction-deterring solution or a cleaning solvent) to certain portions of such fluid dispensers that are particularly susceptible to occlusion due to build-up and/or hardening of fluid within the dispenser.

Foam-in-place packaging is a highly useful technique for on-demand protection of packaged objects. In its most basic form, foam-in-place packaging comprises injecting foamable compositions from a dispenser into a container that holds an object to be cushioned. Typically, the object is wrapped in plastic to keep it from direct contact with the rising (expanding) foam. As the foam rises, it expands into the remaining space between the object and its container (e.g. a corrugated board box) thus forming a custom cushion for the object.

A common foamable composition is formed by mixing an isocyanate compound with a hydroxyl-containing material, such as a polyol (i.e., a compound that contains multiple hydroxyl groups), typically in the presence of water and a catalyst. The isocyanate and polyol precursors react to form polyurethane. At the same time, the water reacts with the isocyanate compound to produce carbon dioxide. The carbon dioxide causes the polyurethane to expand into a foamed cellular structure, i.e., a polyurethane foam, which serves to protect the packaged object.

In other types of foam-in-place packaging, an automated device produces flexible containers, e.g., in the form of bags, from flexible, plastic film and dispenses a foamable composition into the containers as the containers are being formed. As the composition expands into a foam within the container, the container is sealed shut and typically dropped into a box or carton holding the object to be cushioned. The rising foam again tends to expand into the available space, but does so inside the container. Because the containers are formed of flexible plastic, they form individual custom foam cushions around the packaged objects. Exemplary devices for automatically producing foam-in-place cushions in this manner are assigned to the assignee of the present invention, and are illustrated, for example, in U.S. Pat. Nos. 4,800,708, 4,854,109, 5,376,219, and 6,003,288, the contents of each of which are incorporated entirely herein by reference, and in International Application No. PCT/US2019/018865, the contents of which are incorporated entirely herein by reference.

One difficulty with the foamable compositions used to make polyurethane foam for foam-in-place packaging is that the foam precursors and resultant foam tend to have somewhat adhesive properties. As a result, the foamable composition tends to stick to objects and then harden thereon into foam. This tendency is particularly problematic inside of the dispenser from which the foam precursors are ejected. As is known, the polyol and isocyanate foam precursors must be withheld from mixing with one another until just prior to injection. In the most common type of dispenser, the two foam precursors enter the dispenser, mix with one another in an internal chamber disposed within the dispenser to form a foamable composition, and then the resultant foamable composition exits the dispenser via a discharge port. As the dispenser operates over and over again, particularly in automated or successive fashion, foamable composition tends to build up in the internal mixing chamber and around the discharge port of the dispenser, harden into foam, and block the proper exiting of further foamable composition. As a result, the mixing chamber and discharge port must be frequently cleaned to ensure continued operation of the dispenser.

Further, such dispensers generally employ a valving rod that translates longitudinally within the mixing chamber to control the flow of the foam precursors therethrough, i.e., between an ‘open’ position, in which the precursors flow into and through the mixing chamber, and a ‘closed’ position, in which the precursors are prevented from flowing. Such valving rod is in contact with the foam precursors and resultant foamable composition, and thus must also be continually cleaned in order to prevent the build-up of foam thereon, which would otherwise impede and eventually prevent the further movement of the valving rod within the dispenser.

A dispensing solution can be employed to deter reaction of the foamable composition and/or dissolving both the foam precursors and the foamable composition. Such a dispensing solution can be dispensed in particular areas of dispensers to avoid buildup of hardened foam and/or clean the dispensers. In order to clean the dispenser on an on-going basis without the necessity of frequent removal of the dispenser from the cushion-making device for manual cleaning and/or disassembly, dispensing solution is generally contained in a reservoir located behind the mixing chamber and/or supplied to the discharge end of the dispenser from a separate source. Part of the valving rod moves through the reservoir as it translates between open and closed positions to partially clean the valving rod. However, the foam precursors and reaction products thereof gradually contaminate the solvent in the reservoir as they are transferred thereto from the valving rod. This requires periodic removal of the dispenser to either replace it with a dispenser having fresh solvent or to disassemble the cartridge for cleaning and replacement of the solvent.

Known dispensers exist for providing dispensing solution to discharge ports. However, these known solutions have drawbacks. For example, U.S. Pat. No. 6,996,956 describes the delivery of dispensing solution through the valving rod to the discharge port. While this method is effective at delivery solution, the movement of the valving rod does not allow dispensing fluid to be provided to the discharge port during all stages of the dispensing cycle. In another example, U.S. Pat. No. 7,182,221 describes a dispenser with a cap at the discharge end of the dispenser, where the cap serves as a passageway for solvent to be fed to the discharge port. In this design, the cap wears out significantly faster than the dispenser itself such that the cap is a “wear part” that need to be replaced regularly over the lifetime of the dispenser.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In a first embodiment, a fluid dispenser includes a housing and a valving rod. The housing includes a first fluid inlet configured to receive a first fluid product, an internal chamber in fluid communication with the first fluid inlet, a discharge port in fluid communication with the internal chamber and configured to dispense fluid from the internal chamber, a dispensing fluid inlet configured to receive a dispensing fluid, and a dispensing fluid passage system configured to carry the dispensing fluid to the discharge port. The valving rod is disposed in the housing and being movable within the internal chamber between an open position, in which the first fluid product is permitted to flow into the internal chamber, and a closed position, in which the first fluid product is substantially prevented from flowing into the internal chamber. The dispensing fluid passage system comprises a first passageway in fluid communication with the dispensing fluid inlet and arranged to carry the dispensing fluid in a first direction and a second passageway arranged to carry the dispensing fluid in a second direction after the dispensing fluid has passed through the first passageway. The second direction is different from the first direction. The second passageway has a distal end proximate the discharge port such that the dispensing fluid carried by the second passageway exits the distal end of the second passageway proximate the discharge port.

In a second embodiment, the valving rod of the first embodiment moves in a longitudinal direction when moving from the open position to the closed position and the first direction is parallel to the longitudinal direction.

In a third embodiment, the second direction of the second embodiment is at an angle with respect to the longitudinal direction that is both non-parallel and non-perpendicular to the longitudinal direction.

In a fourth embodiment the housing of any of the previous embodiment includes a cavity that is closed at one end by a stopper and the first passageway is a first bore extending from the cavity.

In a fifth embodiment the first bore of the fourth embodiment extends into the housing to a point within the housing that does not reach a discharge end of the housing.

In a sixth embodiment, the second passageway of any of the fourth and fifth embodiments is a second bore extending through the housing from a side of the housing or from a protrusion extending from the side of the housing.

In a seventh embodiment, the first and second bores of the sixth embodiment are arranged such that an axis of the first bore and an axis of the second bore intersect each other and are not parallel to each other.

In an eighth embodiment, the housing of any of the previous embodiments further includes an annular groove in the internal chamber proximate the discharge port, and the distal end of the second passageway opens into the annular groove.

In a ninth embodiment the housing of the first embodiment further includes a first plug bore in a surface of the housing and the first plug bore is in fluid communication with the first and second passageways.

In a tenth embodiment, an axis of the first plug bore of the ninth embodiment is substantially parallel to the second direction.

In an eleventh embodiment, the fluid dispenser of any of the ninth and tenth embodiments further includes a first plug located in at least part of the first plug bore and arranged to seal the first plug bore against the surface of the housing.

In a twelfth embodiment, the first plug of the eleventh embodiment is a machine screw having external threads and at least a portion of the first plug bore includes internal threads configured to engage the external threads of the machine screw.

In a thirteenth embodiment, the surface of the housing of any of the ninth to twelfth embodiments is located on a protrusion extending from a side of the housing.

In a fourteenth embodiment, the housing of any of the previous embodiments further includes a second fluid inlet configured to receive a second fluid product. When the valving rod is in the open position, the second fluid product is permitted to flow into the internal chamber to mix with the first fluid product. When the valving rod is in the closed position, the second fluid product is substantially prevented from flowing into the internal chamber.

In a fifteenth embodiment, the dispensing fluid passage system of any of the previous embodiments further includes a third passageway in fluid communication with the dispensing fluid inlet and arranged to carry the dispensing fluid in the first direction and a fourth passageway arranged to carry the dispensing fluid in a third direction that is different from the first and second directions. The fourth passageway has a distal end. The distal end of the fourth passageway is proximate the discharge port such that the dispensing fluid carried by the fourth passageway exits the distal end of the fourth passageway proximate the discharge port.

In a sixteenth embodiment, the housing of the fifteenth embodiment further includes an annular groove in the internal chamber proximate the discharge port, wherein the distal end of the second passageway and the distal end of the fourth passageway open into the annular groove.

In a seventeenth embodiment, the first and third passageways of any of the fifteenth and sixteenth embodiments are substantially parallel to an axis of the valving rod and wherein the first and third passageways are substantially equidistant from an axis of the valving rod.

In an eighteenth embodiment, the dispensing fluid passage system of any of the fifteenth to seventeenth embodiments further includes a fifth passageway in fluid communication with the dispensing fluid inlet and arranged to carry the dispensing fluid in the first direction and a sixth passageway arranged to carry the dispensing fluid in a fourth direction that is different from the first, second, and third directions. The sixth passageway has a distal end. The distal end of the sixth passageway is proximate the discharge port such that the dispensing fluid carried by the sixth passageway exits the distal end of the fourth passageway proximate the discharge port.

In a nineteenth embodiment, the first, third, and fifth passageways of the eighteenth embodiment are substantially parallel to an axis of the valving rod, wherein the first, third, and fifth passageways are substantially equidistant from an axis of the valving rod, and wherein the first, third, and fifth passageways are substantially equidistant from each other.

In a twentieth embodiment, the fluid dispenser of any of the eighteen and nineteenth embodiments is configured such that: (i) the housing includes a discharge end, a closed end opposite the discharge end, and at least one side extending from the discharge end to the closed end; (ii) each of the first, third, and fifth passageways is a bore extending from the closed end that is closed at the closed end of the housing; (iii) each of the second, fourth, and sixth passageways is a bore extending from one of the side or a protrusion extending from the side; (iv) the bore of the first passageway and the bore of the second passageway are arranged such that an axis of the bore of the first passageway and an axis of the bore of the second passageway intersect each other and are not parallel to each other; (v) the bore of the third passageway and the bore of the fourth passageway are arranged such that an axis of the bore of the third passageway and an axis of the bore of the fourth passageway intersect each other and are not parallel to each other; (vi) the bore of the fifth passageway and the bore of the sixth passageway are arranged such that an axis of the bore of the fifth passageway and an axis of the bore of the sixth passageway intersect each other and are not parallel to each other; and (vii) the fluid dispenser further includes a first plug positioned to close the bore of the second passageway at the one of the side or the protrusion extending from the side, a second plug positioned to close the bore of the fourth passageway at the one of the side or the protrusion extending from the side, and a third plug positioned to close the bore of the sixth passageway at the one of the side or the protrusion extending from the side.

In a twenty first embodiment, an end of the housing of any of the previous embodiments that includes the discharge port has a generally convex or conical shape around the discharge port.

In a twenty second embodiment, the second passageway of any of the previous embodiments extends completely from a side of the housing to the distal end of the second passageway. The fluid dispenser further includes a plug configured to seal the side of the housing from which the second passageway extends.

In a twenty third embodiment, the plug of the twenty second embodiment includes a ring extending around an exterior of the housing.

### BRIEF DESCRIPTION OF THE DRAWING

The foregoing aspects and many of the attendant advantages of the disclosed subject matter will become more readily appreciated as the same become better understood by reference to the following detailed description, when taken in conjunction with the accompanying drawings, wherein:

FIG. 1A depicts a perspective view of an embodiment of a fluid dispenser, in accordance with the embodiments disclosed herein;

FIGS. 1B, 1C, and 1D depict right, rear, and left views of the fluid dispenser shown in FIG. 1A, in accordance with the embodiments disclosed herein;

FIGS. 1E and 1F depict bottom and rear cross-sectional views, respectively, of the fluid dispenser shown in FIG. 1A, in accordance with the embodiments disclosed herein;

FIGS. 1G and 1H depict bottom and front cross-sectional views, respectively, of the fluid dispenser shown in FIG. 1A, in accordance with the embodiments disclosed herein;

FIGS. 2A and 2B depict rear and cross-sectional top views, respectively, of the outer housing of a fluid dispenser, in accordance with the embodiments disclosed herein;

FIG. 2C depicts a bottom view of the outer housing shown in FIGS. 2C, in accordance with the embodiments disclosed herein;

FIGS. 2D, 2E, and 2F depict cross-sectional views of the outer housing, as indicated in FIG. 2C, in accordance with the embodiments disclosed herein;

FIG. 3 depicts a detail view of a portion of the fluid dispenser shown in FIGS. 1A-1H, in accordance with the embodiments disclosed herein;

FIGS. 4A to 4C depict variations of embodiments of a first passageway, a second passageway, and/or a plug shaft in a fluid dispenser, in accordance with the embodiments disclosed herein;

FIG. 5A depicts a bottom view of the fluid dispenser shown in FIGS. 1A-1H, in accordance with the embodiments disclosed herein;

FIGS. 5B-5D depict side cross-sectional views of the fluid dispenser, as indicated in FIG. 5A, and first, second, and third instances, respectively, of an embodiment of a method of using the fluid dispenser, in accordance with the embodiments disclosed herein;

FIG. 6A depicts a bottom view of the fluid dispenser shown in FIGS. 1A-1H, in accordance with the embodiments disclosed herein; and

FIGS. 6B-6D depict side cross-sectional views of the fluid dispenser, as indicated in FIG. 6A, and the first, second, and third instances, respectively, of the embodiment of the method of using the fluid dispenser, in accordance with the embodiments disclosed herein.

### DETAILED DESCRIPTION

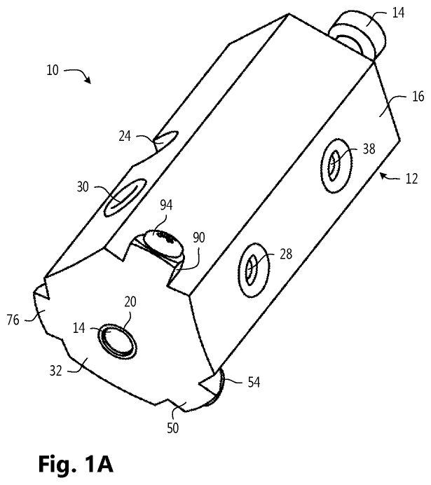

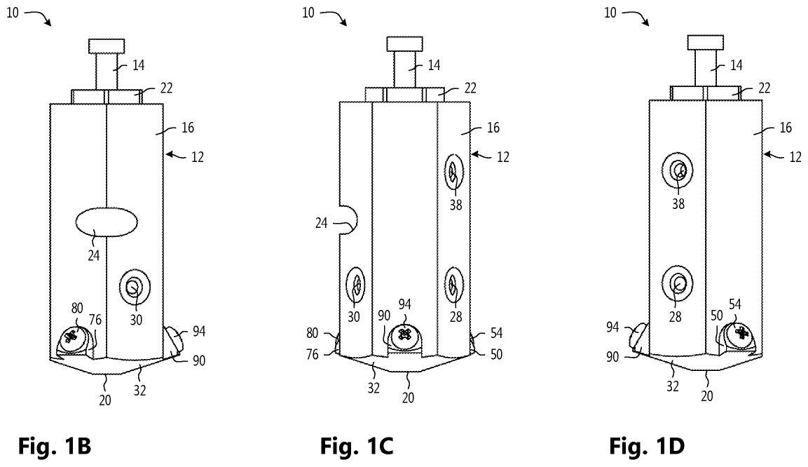

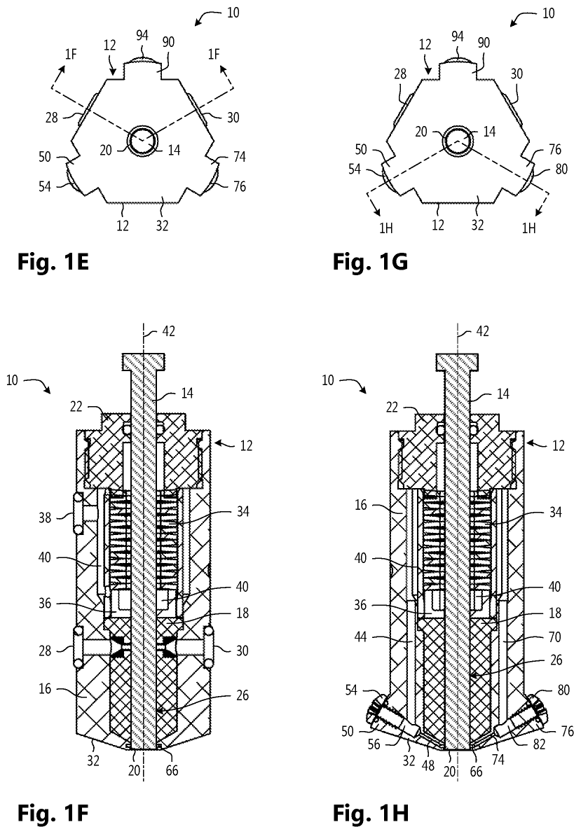

FIG. 1A depicts a perspective view of an embodiment of a fluid dispenser 10. The fluid dispenser 10 is also depicted in right, rear, and left views, respectively, in FIGS. 1B, 1C, and 1D. The fluid dispenser 10 is further depicted in bottom and rear cross-sectional views, respectively, in FIGS. 1E and 1F. The fluid dispenser 10 is further depicted in bottom and front cross-sectional views, respectively, in FIGS. 1G and 1H. As is discussed in greater detail below, the fluid dispenser 10 is capable of dispensing fluid products and dispensing fluid without the need for a wear part (e.g., a wear part on the discharge end of the fluid dispenser 10) to assist in dispensing the dispensing fluid.

The fluid dispenser 10 includes a housing 12 and a valving rod 14. In the depicted embodiment, the housing 12 includes an outer housing 16, a chamber unit 18, a discharge port 20, and a stopper 22. In some embodiments, the outer housing 16 may be constructed from stainless steel or other suitable material that is substantially inert and impervious with respect to the fluid product to be dispensed. The outer housing 16 may be configured to be mounted in and retained by a foam-in-bag machine or other foaming fluid product system. For example, in the depicted embodiment, the outer housing 16 includes a slot 24 that allows the fluid dispenser 10 to be inserted into a dispenser cavity of a foaming fluid product system where the dispenser cavity has a protrusion that ensures proper alignment of the fluid dispenser 10 in the dispenser cavity with the protrusion in the slot 24. In other embodiments, the outer housing 16 of the fluid dispenser 10 could include flanges, mounting holes (e.g., threaded bores for mounting using fasteners), or any other feature that could enable the fluid dispenser 10 to be mounted in and retained by a foaming fluid product system. In other embodiments, the fluid dispenser 10 may be formed in a foaming fluid product system with the housing 12 or portions thereof being an integral unit with the foaming fluid product system.

The housing 12 forms includes an internal chamber 26. In the depicted embodiment, the internal chamber 26 is formed by the chamber unit 18 and the outer housing 16. In particular, the depicted embodiment of the internal chamber 26 is formed mostly by the chamber unit 18 and partially by a portion of the outer housing 16 near the discharge port 20. In the depicted embodiment, the chamber unit 18 is removable from the outer housing 16. It will be understood that, in other embodiments, the chamber unit 18 could be integrally formed with the outer housing 16. It will further be understood that, in other embodiments, the housing 12 may not include a mixing unit and the outer housing 16 could be shaped to form the internal chamber 26.

The housing 12 also includes at least one inlet for receiving a fluid product into the housing 12. In the depicted embodiment, the housing 12 includes a first fluid inlet 28 that is configured to receive a first fluid product. The first fluid inlet 28 is in fluid communication with the internal chamber 26. In the depicted embodiment, the housing 12 further includes a second fluid inlet 30 that is configured to receive a second fluid product. The second fluid inlet 30 is in fluid communication with the internal chamber 26. In this way, the first and second fluid inlets 28 and 30 are capable of receiving respective first and second fluid products such that both of the first and second fluid products are directed to the internal chamber 26 where the first and second fluid products can begin mixing and/or reacting. It will be understood that embodiments of fluid dispensers described herein could have a single fluid product inlet, two fluid product inlets (as depicted), or any greater number of fluid product inlets.

The housing 12 further includes the discharge port 20 that is in fluid communication with the internal chamber 26. In particular, the discharge port 20 is configured to dispense fluid from the internal chamber 26. In the depicted embodiment, the discharge port 20 is located on an end 32 of the housing 12. For example, the end 32 with the discharge port 20 is an end of the outer housing 16. In some embodiments, the end 32 of the housing 12 has a generally convex or conical shape around the discharge port 20. In this way, as fluid is dispensed from the discharge port 20, the generally convex or conical shape of the end 32 of the housing 12 deters the seepage of fluid along the surface of the end 32 of the housing 12. Moreover, when the fluid being dispensed from the discharge port 20 is a formable mixture, the generally convex or conical shape of the end 32 of the housing 12 deters formation and/or adherence of foam on the end 32 of the housing 12.

In some embodiments, the valving rod 14 fits relatively tightly in the chamber unit 18. For example, the outside diameter of the valving rod 14 may be very close to, but slightly less than the inner diameter of the chamber unit 18 that defines the internal chamber 26. For example, the valving rod 14 may have an outside diameter of 0.187 inches (0.475 mm) while the chamber unit 18 may have an inner diameter of 0.189 inches (0.480 mm), for a clearance of about 0.002 inch (0.005 mm). A close fit between the valving rod 14 and the chamber unit 18 may be preferable in reducing the likelihood that fluid product(s) will leak from the internal chamber 26 into other parts of the housing 12.

In some embodiments, the chamber unit 18 is preferably constructed from tetrafluoroethylene (TFE) polymers, fluorinated ethylene-propylene (FEP) polymers, or any other suitable material that is substantially inert and impervious with respect to fluid product(s) and/or dispensing solution to be dispensed by the fluid dispenser 10. It is to be understood, however, that the chamber unit 18 as herein described is not critical any of the embodiments of fluid dispensers described herein, but is merely one means for providing an internal chamber through which fluid product flows and/or in which fluid product components can mix. For example, such internal chamber 26 may instead be provided and defined by an interior surface of the outer housing 16.

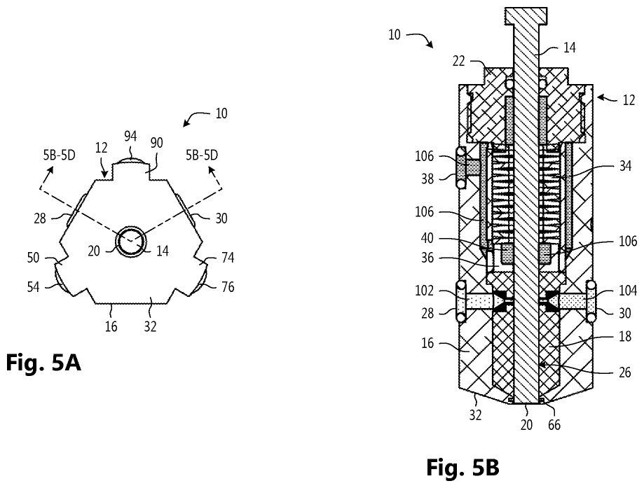

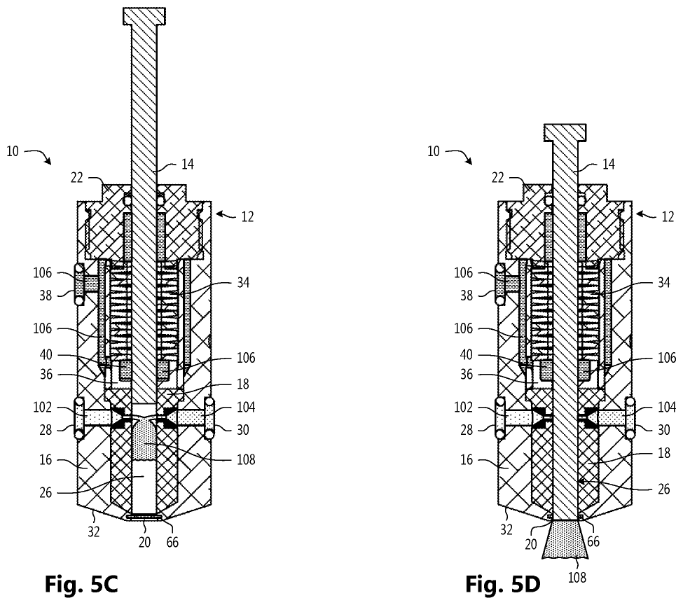

In the depicted embodiments, the valving rod 14 is disposed in housing 12. The valving rod 14 is movable within the internal chamber 26 between an open position and a closed position. When the valving rod 14 is the open position, the first fluid product received by the first fluid inlet 28 is permitted to flow into the internal chamber 26. Similarly, where the fluid dispenser 10 includes the second fluid inlet 30, the second fluid product received by the second fluid inlet 30 is permitted to flow into the internal chamber 26 when the valving rod 14 is the open position. When the valving rod 14 is the closed position, the first fluid product received by the first fluid inlet 28 is substantially prevented from flowing into the internal chamber 26. Similarly, where the fluid dispenser 10 includes the second fluid inlet 30, the second fluid product received by the second fluid inlet 30 is substantially prevented from flowing into the internal chamber 26 when the valving rod 14 is the closed position. In the embodiment shown in FIGS. 1A-1H, the valving rod 14 is the closed position. The valving rod 14 is depicted in the open position in FIGS. 4C and 5C, and described below in the descriptions associated with FIGS. 4C and 5C.

In the depicted embodiment, the valving rod 14 also passes through the stopper 22. The stopper 22 is positioned to close the end of the housing 12 opposite the end 32 that includes the discharge port 20. In some embodiments, the stopper 22 includes has an external circumferential surface that includes an annular groove and the housing 12 (e.g., the outer housing 16) includes an annular ring that engages the annular groove on the stopper 22. In the depicted embodiment, the stopper 22 includes a bore through which the valving rod 14 passes. In some embodiments, the stopper 22 further includes a seal (e.g., an O-ring) configured to deter leakage of fluid through the bore where the valving rod 14 passes.

In the depicted embodiment, the fluid dispenser 10 includes guide rings 34 and a spacer 36 located between the stopper 22 and the internal chamber 26. In some embodiments, the guide rings are configured to assist in maintaining alignment of the valving rod 14 as the valving rod 14 moves between the open and closed positions. In some embodiments, the guide rings 34 are a stack of washers. In some embodiments, the guide rings 34 are configured to exert a compressive force on the chamber unit 18. For example, the guide rings 34 may be Belleville washers stacked between the stopper 22 and the spacer 36 such that the guide rings 34 exert a force on the spacer 36 that, in turn, exerts a compressive force on the chamber unit 18. Such a compressive force on the spacer 36 helps to prevent fluid product from leaking between the valving rod 14 and the chamber unit 18 when the valving rod 14 is in the closed position.

The valving rod 14 may be moved between the open and closed positions by any suitable mechanism, such as an actuating mechanism. For example, an actuating mechanism may include an actuator and a drive arm. The actuator may be powered electrically, pneumatically, or otherwise, and may cause the drive arm to reciprocate both toward and away from the fluid dispenser 10. The drive arm may, in turn, be mechanically connected to the valving rod 14 (e.g., via a slot). In this fashion, when drive arm reciprocates away from the fluid dispenser 10, the valving rod 14 assumes the open position and, conversely, when the drive arm reciprocates toward the fluid dispenser 10, the valving rod 14 assumes the closed position.

When used with first and second fluid products that can mix together and react to form a foamable composition, as the dispenser operates over and over again—particularly in automated or successive fashion—the foamable composition has a tendency to build up in the internal chamber 26, particularly and around the discharge port 20. Such build-up of the foamable composition can harden into foam and block the proper exiting of further foamable composition. The embodiments of fluid dispensers described herein provide an improved means for continually deterring the build-up proximate the discharge port 20. In particular, the embodiments of fluid dispensers described herein provide an improved dispensing fluid passage system to dispense dispensing fluid proximate the discharge port 20.

The housing 12 further includes a dispensing fluid inlet 38 configured to receive a dispensing fluid. In some embodiments, the dispensing fluid is configured to deter reaction of fluid products and/or to clean fluid products from surfaces. In the depicted embodiment, the outer housing 16 defines a cavity 40 that is in fluid communication with the fluid inlet 38. In the depicted embodiment, the stopper 22, the guide rings 34, and the spacer 36 are located in the cavity 40. In this way, the dispensing fluid fills the cavity 40 around the valving rod 14, the guide rings 34, and the spacer 36. In the depicted embodiment, the housing 12 generally has a longitudinal axis 42. In some embodiments, the cavity 40 and/or the internal chamber 26 are axially aligned with the axis 42 of the housing 12. In some embodiments, the valving rod 14 is axially aligned with the axis 42 of the housing 12 and the valving rod 14 translates between the open and closed positions along the longitudinal axis 42.

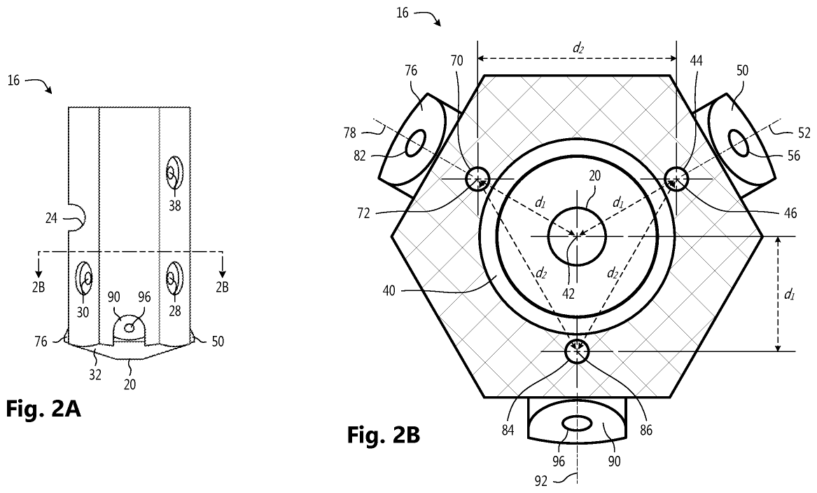

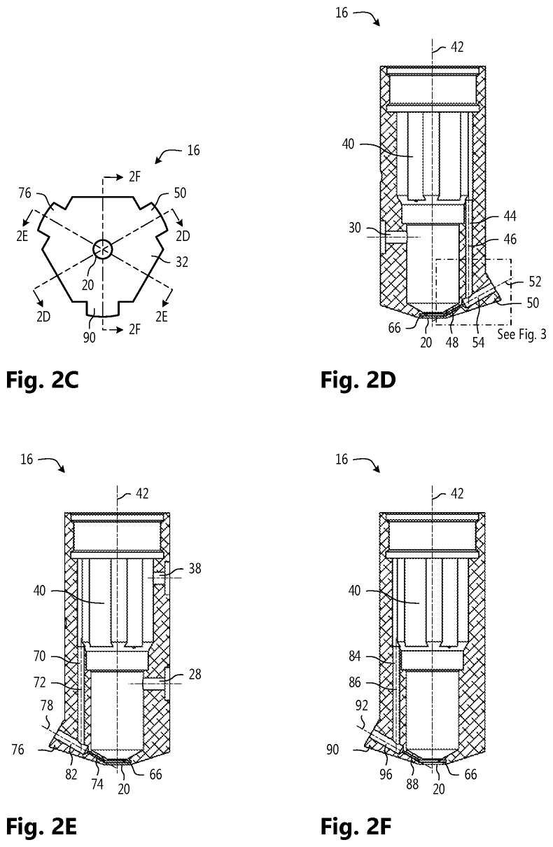

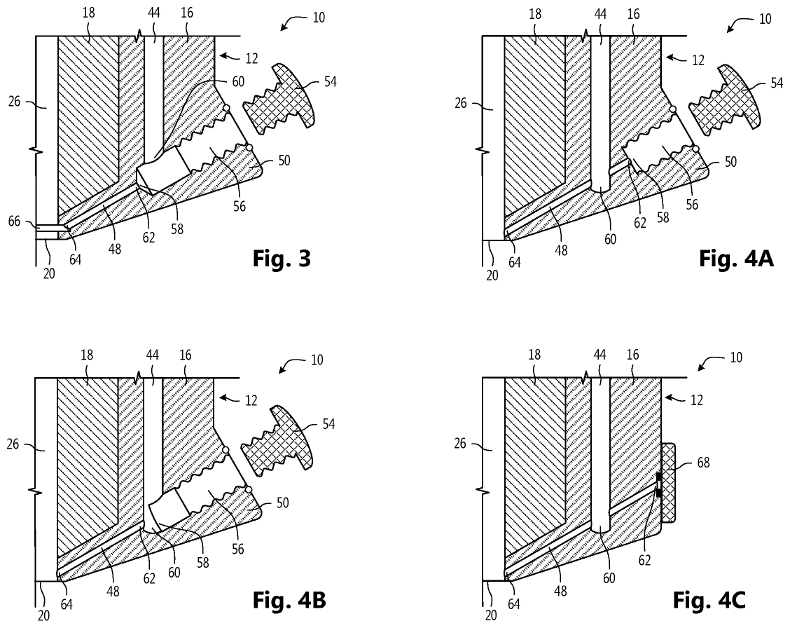

The housing 12 further includes a dispensing fluid passage system that is configured to carry the dispensing fluid to the discharge port 20. The dispensing fluid passage system can be seen in part in FIGS. 1A-1H. The dispensing fluid passage system can also be seen in part in depictions of the outer housing 16 in FIGS. 2A-2F and in FIG. 3. FIGS. 2A and 2B depict rear and cross-sectional top views, respectively, of the outer housing 16. FIG. 2C depicts a bottom view of the outer housing 16. FIGS. 2D, 2E, and 2F depict cross-sectional views of the outer housing 16, as indicated in FIG. 2C. As indicated in FIG. 2D, a detail view of a portion of the fluid dispenser 10 is shown in FIG. 3.

The dispensing fluid passage system includes a first passageway 44 that is in fluid communication with the dispensing fluid inlet 38. In the depicted embodiment, the first passageway 44 is in fluid communication with the dispensing fluid inlet 38 via the cavity 40. In the depicted embodiment, the first passageway 44 is a bore in the outer housing 16 that was formed downward from the cavity 40 toward the end 32. However, the bore does not reach the end 32. The bore has an axis 46 that is substantially parallel to the axis 42 of the housing 12. The first passageway 44 is configured to carry the dispensing fluid in a first direction. In the depicted embodiment, the first passageway 44 is configured to carry the dispensing fluid downward in a direction parallel to the axis 46 of the bore.

The dispensing fluid passage system includes a second passageway 48 that is in fluid communication with the first passageway 44. The first and second passageways 44 and 48 are arranged such that dispensing fluid passes through the second passageway 48 after the dispensing fluid passes through the first passageway 44. In the depicted embodiment, the second passageway 48 is a bore in the outer housing 16 that was formed at an angle from a protrusion 50 extending from the side of the outer housing 16. In the depicted embodiment, the bore of the second passageway 48 extends completely through the outer housing 16 from the protrusion 50 to location proximate the discharge port 20. The bore of the second passageway 48 has an axis 52 that is not parallel to the axis 46 of the first passageway 44. In this way, after the dispensing fluid passes through the first passageway 44, the second passageway 48 is configured to carry the dispensing fluid in a second direction that is different from the first direction. In the depicted embodiment, the second passageway 48 is configured to carry the dispensing fluid in a direction parallel to the axis 52 of the bore. In some embodiments, the axis 46 of the first passageway 44 intersects the axis 52 of the second passageway 48. In some embodiments, the axis 52 of the second passageway 48 also intersects the axis 42 of the outer housing 16.

In some embodiments, the fluid dispenser 10 includes a plug 54 configured to seal the side of the housing 12 from which the second passageway 48 was formed. In the depicted embodiment, the housing 12 includes a plug bore 56 that extends from the protrusion 50 on the side of the housing 12. In some embodiments, the plug 54 is a machine screw having external threads and at least a portion of the plug bore 56 has internal thread that engage the external threads of the machine screw. As can be seen in FIG. 3, the housing can include a sealing mechanism (e.g., an O-ring) at the surface of the side of the housing 12 such that the plug 54 (e.g., the head of the machine screw) seals against the side of the housing 12.

The plug bore 56 extends into the outer housing 16 to a distal end 58 of the plug bore 56. In the embodiment shown in FIG. 3, the distal end 58 of the plug bore 54 is located such that such that a distal end 60 of the first passageway 44 opens into the plug bore 56. Also, a proximal end 62 of the second passageway 48 is located at the distal end 58 of the plug bore 56. A distal end 64 of the second passageway 48 is proximate the discharge port 20. In the depicted embodiment, the distal end 64 of the second passageway 48 opens into an annular groove 66 of the outer housing 16, where the annular groove 66 is proximate the discharge port 20. It will be understood that the annular groove 66 is not essential to the embodiments disclosed herein, but it may be advantageous for the annular groove 66 to be located proximate the discharge port 20 to provide dispensing solution around the entirety of the discharge port 20.

One benefit of the depicted dispensing fluid passage system—including the first and second passageways 44 and 48—is that the dispensing fluid passage system is able to be manufactured in the housing 12 while permitting the dispensing fluid to be carried in two directions without the need for any wear parts. In the embodiment where the first and second passageways 44 and 48 are bores, the bores can be made in the outer housing 16 from either the cavity 40 or the side of the outer housing 16. One of the first and second passageways 44 and 48 carries the dispensing fluid in one direction and the other of the first and second passageways 44 and 48 carries the dispensing fluid in another direction. In the depicted embodiment, the first passageway 44 carries the dispensing fluid substantially parallel to the axis 42 of the housing 12 and the second passageway 48 carries the dispensing fluid toward the axis 42 of the housing 12 to dispense the dispensing fluid proximate the discharge port 20. In the depicted embodiment, the plug 54 seals the side of the housing 12 where the second passageway 48 is open such that dispensing fluid will not leak out the side of the housing 12 but will instead be carried by the second passageway 48 to the discharge port 20. Additionally, the plug 54 is not adversely affected to the extent that the plug 54 would need to be replaced before the fluid dispenser 10 would otherwise be replaced. Thus, the plug 54 is not a wear part of the fluid dispenser 10.

Variations of embodiments of the first passageway 44, the second passageway 48, and/or the plug bore 56 are shown in FIGS. 4A to 4C. In FIG. 4A, the plug bore 56 does not intersect the first passageway 44. In this embodiment, the first passageway 44 and the second passageway 48 intersect each other with the distal end 60 of the first passageway 44 located below the second passageway 48. The proximal end 62 of the second passageway 48 is still located at the distal end 58 of the plug bore 56. Also, the distal end 64 of the second passageway 48 opens directly into the internal chamber 26 proximate the discharge port 20. In this embodiment, there is no annular groove in the internal chamber 26 at the distal end 64 of the second passageway 48. The plug 54 can be threaded into the plug bore 56 in order to seal the surface of the housing 12 on the protrusion 50.

In FIG. 4B, the distal end 60 of the first passageway 44 is located in substantially the same location as in the embodiment shown in FIG. 4A. As can be seen in FIG. 4B, the plug bore 56 extends into the outer housing 16 such that the plug bore 56 partially intersects the first passageway 44. The distal end 58 of the plug bore 56 is located in the first passageway 44. The second passageway 48 also intersects the first passageway 44 with the proximal end 62 of the second passageway 48 located at the intersection of the first and second passageways 44 and 48. The plug 54 can be threaded into the plug bore 56 in order to seal the surface of the housing 12 on the protrusion 50.

In FIG. 4C, the housing includes the first and second passageways 44 and 48 but does not include a plug bore. The distal end 60 of the first passageway 44 is located in substantially the same location as in the embodiments shown in FIGS. 4A and 4B. As can be seen in FIG. 4C, the proximal end 62 of the first passageway 48 is located proximate the surface of the outer housing 16 from which the first passageway 48 is formed. In the depicted embodiment, the fluid dispenser includes a plug 68 in the form of a ring that extends around outer housing 16 of the fluid dispenser. In some embodiments, the ring has a shape corresponding to a cross-sectional shape of the outer housing 16 (e.g., a circular cross-sectional shape, a hexagonal cross-sectional shape, etc.). In some embodiments where the outer housing 16 has a circular cross-sectional shape and the plug 68 is a ring with a circular shape, the outer housing 16 may include external threads and the plug 68 may include internal threads to enable the plug 68 to be coupled to and uncoupled from the outer housing 16. Even though the plug 68 does not extend into the housing 12, the plug 68 is still capable of sealing the surface on the side of the housing 12 from which the second passageway 48 is formed so that dispensing fluid does not leak out the side of the housing 12. In the depicted embodiment, the outer housing 16 does not include a protrusion from the side of the housing 12.

It will be understood that any of the features of the embodiments shown in FIGS. 3 and 4A-4C could be used in any of the fluid dispensers described herein. Moreover, the features of the embodiments shown in FIGS. 3 and 4A-4C could be combined in any number of different ways in any of the fluid dispensers described herein. For example, any of the embodiments in FIGS. 4A-4C could include an annular grove in the internal chamber 26 at the distal end 64 of the second passageway 48. In another example, any of the embodiments in FIGS. 3 and 4A-4B could lack a protrusion on the side of the housing 12. In other embodiments, any other feasible combination of the features in FIGS. 3 and 4A-4C could be used in a fluid dispenser.

In some embodiments, the first and second passageways 44 and 48 are the only passageways in the dispensing fluid passage system that carry dispensing fluid to the discharge port 20. In some embodiments, including the embodiment of the fluid dispenser 10 depicted in FIGS. 1A-1H and the embodiment of the outer housing 16 depicted in FIGS. 2A-2F, the dispensing fluid passage system can include additional passageways. Referring back to FIGS. 1A-2F, the dispensing fluid passage system further includes a third passageway 70 that is in fluid communication with the dispensing fluid inlet 38. In the depicted embodiment, the third passageway 70 is in fluid communication with the dispensing fluid inlet 38 via the cavity 40. In the depicted embodiment, the third passageway 70 is a bore in the outer housing 16 that was formed downward from the cavity 40 toward the end 32. However, the bore does not reach the end 32. The bore has an axis 72 that is substantially parallel to the axis 42 of the housing 12. The third passageway 70 is configured to carry the dispensing fluid in the first direction that the first passageway 44 carries the dispensing fluid. In the depicted embodiment, the third passageway 70 is configured to carry the dispensing fluid downward in a direction parallel to the axis 72 of the bore of the third passageway 70.

The dispensing fluid passage system includes a fourth passageway 74 that is in fluid communication with the third passageway 70. The third and fourth passageways 70 and 74 are arranged such that dispensing fluid passes through the fourth passageway 74 after the dispensing fluid passes through the third passageway 70. In the depicted embodiment, the fourth passageway 74 is a bore in the outer housing 16 that was formed at an angle from a protrusion 76 extending from the side of the outer housing 16. In the depicted embodiment, the bore of the fourth passageway 74 extends completely through the outer housing 16 from the protrusion 76 to a location proximate the discharge port 20. The bore of the fourth passageway 74 has an axis 78 that is not parallel to the axis 72 of the third passageway 70. In this way, after the dispensing fluid passes through the third passageway 70, the fourth passageway 74 is configured to carry the dispensing fluid in a third direction that is different from the first and second directions. In the depicted embodiment, the fourth passageway 74 is configured to carry the dispensing fluid in a direction parallel to the axis 78 of the bore of the fourth passageway 74. In some embodiments, the axis 72 of the third passageway 70 intersects the axis 78 of the fourth passageway 76. In some embodiments, the axis 78 of the fourth passageway 76 also intersects the axis 42 of the outer housing 16.

In some embodiments, the fluid dispenser 10 includes a plug 80 configured to seal the side of the housing 12 from which the fourth passageway 74 was formed. In the depicted embodiment, the housing 12 includes a plug bore 82 that extends from the protrusion 76 on the side of the housing 12. In some embodiments, the plug 82 is a machine screw having external threads and at least a portion of the plug bore 82 has internal threads that engage the external threads of the machine screw. The housing 12 can include a sealing mechanism (e.g., an O-ring) at the surface of the side of the housing 12 such that the plug 82 seals against the side of the housing 12.

The plug bore 82 extends into the outer housing 16 to a distal end of the plug bore 82. In the depicted embodiment, the distal end of the plug bore 82 is located such that such that a distal end of the third passageway 70 opens into the plug bore 82. Also, a proximal end of the fourth passageway 74 is located at the distal end of the plug bore 82. A distal end of the fourth passageway 74 is proximate the discharge port 20. In the depicted embodiment, the distal end of the fourth passageway 74 opens into the annular groove 66 of the outer housing 16 that is proximate the discharge port 20. As noted above, the annular groove 66 is not essential to the embodiments disclosed herein, but the annular groove 66 may be advantageous in certain situations.

In some embodiments, the first, second, third, and fourth passageways 44, 48, 70, 74 are the only passageways in the dispensing fluid passage system that carry dispensing fluid to the discharge port 20. In some embodiments, including the depicted embodiment of the fluid dispenser 10, the dispensing fluid passage system can include additional passageways. In the depicted embodiment, the dispensing fluid passage system further includes a fifth passageway 84 that is in fluid communication with the dispensing fluid inlet 38. In the depicted embodiment, the fifth passageway 84 is in fluid communication with the dispensing fluid inlet 38 via the cavity 40. In the depicted embodiment, the fifth passageway 84 is a bore in the outer housing 16 that was formed downward from the cavity 40 toward the end 32. However, the bore does not reach the end 32. The bore has an axis 86 that is substantially parallel to the axis 42 of the housing 12. The fifth passageway 84 is configured to carry the dispensing fluid in the first direction that the first passageway 44 carries the dispensing fluid. In the depicted embodiment, the fifth passageway 84 is configured to carry the dispensing fluid downward in a direction parallel to the axis 86 of the bore of the fifth passageway 84.

The dispensing fluid passage system includes a sixth passageway 88 that is in fluid communication with the fifth passageway 84. The fifth and sixth passageways 84 and 88 are arranged such that dispensing fluid passes through the sixth passageway 88 after the dispensing fluid passes through the fifth passageway 84. In the depicted embodiment, the sixth passageway 88 is a bore in the outer housing 16 that was formed at an angle from a protrusion 90 extending from the side of the outer housing 16. In the depicted embodiment, the bore of the sixth passageway 88 extends completely through the outer housing 16 from the protrusion 90 to a location proximate the discharge port 20. The bore of the sixth passageway 88 has an axis 92 that is not parallel to the axis of the fifth passageway 84. In this way, after the dispensing fluid passes through the fifth passageway 84, the sixth passageway 88 is configured to carry the dispensing fluid in a fourth direction that is different from the first, second, and third directions. In the depicted embodiment, the sixth passageway 88 is configured to carry the dispensing fluid in a direction parallel to the axis 92 of the bore of the sixth passageway 88. In some embodiments, the axis 86 of the fifth passageway 84 intersects the axis 92 of the sixth passageway 88. In some embodiments, the axis 92 of the sixth passageway 88 also intersects the axis 42 of the outer housing 16.

In some embodiments, the fluid dispenser 10 includes a plug 94 configured to seal the side of the housing 12 from which the sixth passageway 88 was formed. In the depicted embodiment, the housing 12 includes a plug bore 96 that extends from the protrusion 90 on the side of the housing 12. In some embodiments, the plug 94 is a machine screw having external threads and at least a portion of the plug bore 96 has internal threads that engage the external threads of the machine screw. The housing 12 can include a sealing mechanism (e.g., an O-ring) at the surface of the side of the housing 12 such that the plug 94 seals against the side of the housing 12.

The plug bore 96 extends into the outer housing 16 to a distal end of the plug bore 82. In the depicted embodiment, the distal end of the plug bore 96 is located such that such that a distal end of the fifth passageway 84 opens into the plug bore 96. Also, a proximal end of the sixth passageway 88 is located at the distal end of the plug bore 96. A distal end of the sixth passageway 88 is proximate the discharge port 20. In the depicted embodiment, the distal end of the sixth passageway 88 opens into the annular groove 66 of the outer housing 16 that is proximate the discharge port 20. As noted above, the annular groove 66 is not essential to the embodiments disclosed herein, but the annular groove 66 may be advantageous in certain situations.

FIG. 2B depicts one embodiment of an arrangement of the passageways of the dispensing fluid passage system with respect to each other and with respect to the outer housing 16. In the depicted embodiment, the axis 52 of the second passageway 48 intersects both the axis 46 of the first passageway 44 and the axis 42 of the outer housing 16, the axis 78 of the fourth passageway 74 intersects both the axis 72 of the third passageway 70 and the axis 42 of the outer housing 16, and the axis 92 of the sixth passageway 88 intersects both the axis 86 of the fifth passageway 84 and the axis 42 of the outer housing 16. Also in the depicted embodiment, each of the axes 46, 72, and 86 is positioned at a distance d₁ with respect to the axis 42 of the outer housing 16. Thus, when the valving rod 14 is positioned coaxially with the axis 42 of the outer housing 16, the first, third, and fifth passageways 44, 70, and 84 are substantially equidistant from the axis of the valving rod 14. Also in the depicted embodiment, each of the axes 46, 72, and 86 is positioned at a distance d₂ with respect to each of the other two of the axes 46, 72, and 86. Thus, when the valving rod 14 is positioned coaxially with the axis 42 of the outer housing 16, the first, third, and fifth passageways 44, 70, and 84 are substantially equidistant from the axis of the valving rod 14, and the first, third, and fifth passageways 44, 70, and 84 are substantially equidistant from each other. It will be understood that the depicted arrangement is only one of many potential arrangements of passageways of the dispensing fluid passage system and that the depicted arrangement is not essential to operation of the fluid dispenser 10.

In the depicted embodiment, the dispensing fluid passage system includes three separate paths for the dispensing fluid to be delivered to locations proximate the discharge port 20. A first path includes the first and second passageways 44 and 48; a second path includes the third and fourth passageways 70 and 74; and a third path includes the fifth and sixth passageways 84 and 88. One benefit to having an increased number of paths for the dispensing fluid to be delivered to locations proximate the discharge port 20 is that the dispensing fluid can be dispensed to multiple sides of the discharge port 20, thereby increasing the effectiveness of the dispensing fluid at the discharge port 20. Conversely, the greater the number of paths for the dispensing fluid to be delivered to locations proximate the discharge port 20, the greater the complexity of the design and the cost of manufacturing the housing 12. Thus, any number of paths (i.e., one path or a plurality of paths) may be selected for the dispensing fluid passage system depending on the desired operation of the dispensing fluid passage system, the complexity of the dispensing fluid passage system, and/or the cost to manufacture the housing 12.

In some embodiments of dispensing fluid passage systems, the passageways with the smallest cross-sectional areas are the passageways that carry the dispensing fluid to locations proximate the discharge port. In the depicted embodiment, the passageways with the smallest cross-sectional areas are the second, fourth, and sixth passageways 48, 74, 88, which carry the dispensing fluid to locations proximate the discharge port 20. With the passageways that carry the dispensing fluid to locations proximate the discharge port having the smallest cross-sectional areas of the passageways in the dispensing fluid passage systems, the resulting flow of the dispensing fluid can have a spraying effect (or jet-like effect) that more efficiently and/or effectively delivers the dispensing fluid to the discharge port 20 and/or the valving rod 14.

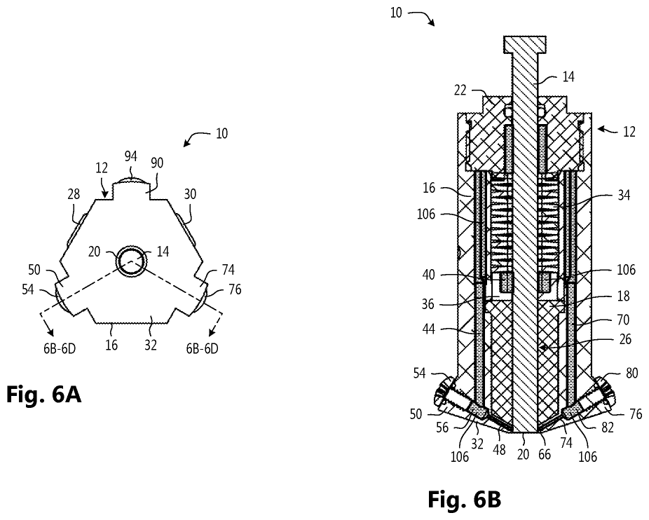

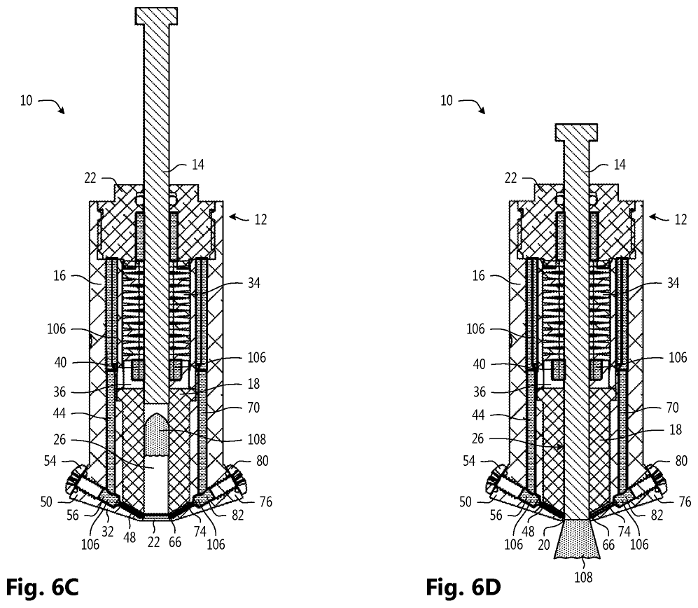

FIGS. 5A-6D depict an embodiment of a method of using the fluid dispenser 10. More specifically, FIGS. 5A and 6A depict bottom views of the fluid dispenser 10, FIGS. 5B-5D depict side cross-sectional views of the fluid dispenser 10 as indicated in FIG. 5A, and FIGS. 6B-6D depict side cross-sectional views of the fluid dispenser 10 as indicated in FIG. 6A. FIGS. 5B and 6B depict a first instance of the method, FIGS. 5C and 6C depict a second instance of the method, and FIGS. 5D and 6D depict a third instance of the method. In all three of the instances, the first fluid inlet 28 is coupled to a source (not shown) of a first fluid product 102, the second fluid inlet 30 is coupled to a source (not shown) of a second fluid product 104, and the dispensing fluid inlet 38 is coupled to a source (not shown) of a dispensing fluid 106. FIGS. 5B-5D and 6B-6D depict flows of the first fluid product 102, the second fluid product 104, and the dispensing fluid 106 within the fluid dispenser 10.

At the first instance shown in FIGS. 5B and 6B, the valving rod 14 is in the closed position. When the valving rod 14 is in the closed position, the first fluid product 102 and the second fluid product 104 are substantially prevented from flowing into the internal chamber 26. As can be seen in FIG. 5B, the first fluid product 102 is capable of filling conduits between the first fluid inlet 28 and the internal chamber 26 and the second fluid product 104 is capable of filling conduits between the second fluid inlet 30 and the internal chamber 26. However, the valving rod 14 substantially prevents the flow of the first and second fluid products 102 and 104 into the internal chamber 26.

The dispensing fluid 106 has flowed in through the dispensing fluid inlet 38 and filled portions of the cavity 40 and the dispensing fluid passage system. In one example, the dispensing fluid 106 is located in the portions of the cavity 40 that are not filled by the valving rod 14, the guide rings 34, and the spacer 36. In this way, the dispensing fluid 106 in the portions of the cavity are able to deter reaction of any of the first and second fluid products 102 and 104 that seep into the cavity 40 and/or clean any build-up of the first and second fluid products 102 and 104 that seep into the cavity 40. In another example, the dispensing fluid 106 is in the first, second, third, fourth, fifth, and sixth passageways 44, 48, 70, 74, 84, and 88 of the dispensing fluid passage system. At the instance depicted in FIGS. 5B and 6B, the dispensing fluid discharged from the dispensing fluid passage system proximate the discharge port 20 can coat the exterior diameter of the valving rod 14. In the depicted embodiment, that includes the annular groove 66, the dispensing fluid discharged from the dispensing fluid passage system can coat the entire exterior diameter of the valving rod 14 that is exposed at the annular groove 66.

At the second instance shown in FIGS. 5C and 6C, the valving rod 14 is in the open position. When the valving rod 14 is in the open position, the first fluid product 102 and the second fluid product 104 are permitted to flow into the internal chamber 26. This flow of the first and second fluid products 102 and 104 allows the first and second fluid products 102 and 104 to mix together in the internal chamber 26 to form a mixed composition 108. In the embodiments where the first and second fluid products 102 and 104 are capable of reacting together to form a foam, the mixed composition 108 is a foamable composition. When the valving rod 14 is in the open position, the dispensing fluid is able to flow out of the second, fourth, and sixth passageways 48, 74, and 88 toward the discharge port 20. In this way, the dispensing fluid 106 can coat portions of the internal chamber 26 proximate the annular groove 66, portions of the internal chamber 26 proximate the discharge port 20, and portions of the end 32 proximate the discharge port 20. This coating by the dispensing fluid can deter reaction of any of the first and second fluid products 102 and 104 that remains in those areas and/or clean any build-up of the first and second fluid products 102 and 104 in those areas.

At the third instance shown in FIGS. 5D and 6D, the valving rod 14 has returned to the closed position. In returning to the closed position, the valving rod 14 forces substantially all of the mixed composition 108 out of the internal chamber 26 through the discharge port 20. In this way, the fluid dispenser 10 is able to dispense the mixed composition 108 in “shots” of the mixed composition 108. Some of the dispensing fluid 106 may mix with the mixed composition 108 as the mixed composition 108 is dispensed, but the ratio of the volume of the dispensing fluid 106 to the mixed composition 108 is low enough not to have significant adverse effects on the reaction of the mixed composition 108.

The method depicted in FIGS. 5B-5D and 6B-6D can be repeated any number of times to continue dispensing shots of the mixed composition 108 from the fluid dispenser 10. As the fluid dispenser 10 dispenses shots of the mixed composition 108, the dispensing fluid passage system can continue to dispense dispensing fluid to deter reaction of the first and second fluid products 102 and 104 and/or clean the first and second fluid products 102 and 104 on the valving rod 14, the internal chamber 26, the discharge port 20, and/or the end 32 of the housing 12. The effect of the dispensing fluid dispensed from the dispensing fluid passage system may enable the fluid dispenser 10 to continue dispensing shots of the dispensing fluid for longer periods of time before the fluid dispenser 10 needs to be take out of service for deep cleaning.

Another benefit to the embodiments of fluid dispensers described herein is that performing a deep clean of a fluid dispenser may be easier because of the plugs on the sides of the housing. In particular, when the fluid dispenser 10 is deep cleaned, the plugs 54, 80, and 94 can be removed from the housing 12. Once the plugs 54, 80, and 94 are removed. The plug bores 56, 82, and 96 and the second, fourth, and sixth passageways 48, 74, and 88 are accessible for cleaning mechanically, such as using a scraping device to dislodge building of the first and second fluid products 102 and 104 and/or any resulting products thereof (e.g., foam) by inserting the scraping device through the holes where the plugs 54, 80, and 94 were removed. This benefit would also be the case where the fluid dispenser had another type of plug, such as the plug 68 in the form of a ring. Such a plug 68 could be removed to allow for scraping through the hole or holes that had previously been covered by the plug 68.

The embodiments of fluid dispensers described herein can be used to dispense fluid into flexible containers (e.g., bags) and enclosing the fluid within containers formed from film webs. Film webs may comprise any flexible material, such as, e.g., various thermoplastic or fibrous materials such as polyethylene or paper. Preferably, film webs are flexible, thermoplastic films, and may be formed from any polymeric material capable of being formed into a foam-in-bag cushion as described herein. Non-limiting examples include polyethylene homopolymers, such as low density polyethylene (LDPE) and high density polyethylene (HDPE), and polyethylene copolymers such as, e.g., ionomers, EVA, EMA, heterogeneous (Zeigler-Natta catalyzed) ethylene/alpha-olefin copolymers, and homogeneous (metallocene, single-cite catalyzed) ethylene/alpha-olefin copolymers. Ethylene/alpha-olefin copolymers are copolymers of ethylene with one or more comonomers selected from C3 to C20 alpha-olefins, such as 1-butene, 1-pentene, 1-hexene, 1-octene, methyl pentene and the like, in which the polymer molecules comprise long chains with relatively few side chain branches, including linear low density polyethylene (LLDPE), linear medium density polyethylene (LMDPE), very low density polyethylene (VLDPE), and ultra-low density polyethylene (ULDPE). Various other materials are also suitable such as, e.g., polypropylene homopolymer or polypropylene copolymer (e.g., propylene/ethylene copolymer), polyesters, polystyrenes, polyamides, polycarbonates, etc. The film(s) may be monolayer or multilayer films and can be made by any known coextrusion process by melting the component polymer(s) and extruding or coextruding them through one or more flat or annular dies.

For purposes of this disclosure, terminology such as “upper,” “lower,” “vertical,” “horizontal,” “inwardly,” “outwardly,” “inner,” “outer,” “front,” “rear,” and the like, should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Unless stated otherwise, the terms “substantially,” “approximately,” and the like are used to mean within 5% of a target value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

What is claimed is:

1. A fluid dispenser, comprising:
a housing including:
a first fluid inlet configured to receive a first fluid product,
an internal chamber in fluid communication with the first fluid inlet,
a discharge port in fluid communication with the internal chamber and configured to dispense fluid from the internal chamber,
a dispensing fluid inlet configured to receive a dispensing fluid, and
a dispensing fluid passage system configured to carry the dispensing fluid to the discharge port; and
a valving rod disposed in the housing and being movable within the internal chamber between an open position, in which the first fluid product is permitted to flow into the internal chamber, and a closed position, in which the first fluid product is substantially prevented from flowing into the internal chamber;
wherein the dispensing fluid passage system comprises:
a first passageway in fluid communication with the dispensing fluid inlet and arranged to carry the dispensing fluid in a first direction, and
a second passageway arranged to carry the dispensing fluid in a second direction after the dispensing fluid has passed through the first passageway, wherein the second direction is different from the first direction, and wherein the second passageway has a distal end proximate the discharge port such that the dispensing fluid carried by the second passageway exits the distal end of the second passageway proximate the discharge port.

2. The fluid dispenser of claim 1, wherein the valving rod moves in a longitudinal direction when moving from the open position to the closed position, and wherein the first direction is parallel to the longitudinal direction.

3. The fluid dispenser of claim 2, wherein the second direction is at an angle with respect to the longitudinal direction that is both non-parallel and non-perpendicular to the longitudinal direction.

4. The fluid dispenser of claim 1, wherein the housing includes a cavity that is closed at one end by a stopper, and wherein the first passageway is a first bore extending from the cavity.

5. The fluid dispenser of claim 4, wherein the first bore extends into the housing to a point within the housing that does not reach a discharge end of the housing.

6. The fluid dispenser of claim 4, wherein the second passageway is a second bore extending through the housing from a side of the housing or from a protrusion extending from the side of the housing.

7. The fluid dispenser of claim 6, wherein the first and second bores are arranged such that an axis of the first bore and an axis of the second bore intersect each other and are not parallel to each other.

8. The fluid dispenser of claim 1, wherein the housing further comprises an annular groove in the internal chamber proximate the discharge port, and wherein the distal end of the second passageway opens into the annular groove.

9. The fluid dispenser of claim 1, wherein the housing further comprises a first plug bore in a surface of the housing, wherein the first plug bore is in fluid communication with the first and second passageways.

10. The fluid dispenser of claim 9, wherein an axis of the first plug bore is substantially parallel to the second direction.

11. The fluid dispenser of claim 9, further comprising:
a first plug located in at least part of the first plug bore and arranged to seal the first plug bore against the surface of the housing.

12. The fluid dispenser of claim 11, wherein the first plug is a machine screw having external threads and wherein at least a portion of the first plug bore includes internal threads configured to engage the external threads of the machine screw.

13. The fluid dispenser of claim 9, wherein the surface of the housing is located on a protrusion extending from a side of the housing.

14. The fluid dispenser of claim 1, wherein the housing further comprises:
a second fluid inlet configured to receive a second fluid product;
wherein, when the valving rod is in the open position, the second fluid product is permitted to flow into the internal chamber to mix with the first fluid product; and
wherein, when the valving rod is in the closed position, the second fluid product is substantially prevented from flowing into the internal chamber.

15. The fluid dispenser of claim 1, wherein the dispensing fluid passage system further comprises:
a third passageway in fluid communication with the dispensing fluid inlet and arranged to carry the dispensing fluid in the first direction, and
a fourth passageway arranged to carry the dispensing fluid in a third direction that is different from the first and second directions, the fourth passageway having a distal end, wherein the distal end of the fourth passageway is proximate the discharge port such that the dispensing fluid carried by the fourth passageway exits the distal end of the fourth passageway proximate the discharge port.

16. The fluid dispenser of claim 15, wherein the housing further comprises an annular groove in the internal chamber proximate the discharge port, wherein the distal end of the second passageway and the distal end of the fourth passageway open into the annular groove.

17. The fluid dispenser of claim 15, wherein the first and third passageways are substantially parallel to an axis of the valving rod and wherein the first and third passageways are substantially equidistant from an axis of the valving rod.

18. The fluid dispenser of claim 15, wherein the dispensing fluid passage system further comprises:
a fifth passageway in fluid communication with the dispensing fluid inlet and arranged to carry the dispensing fluid in the first direction, and
a sixth passageway arranged to carry the dispensing fluid in a fourth direction that is different from the first, second, and third directions, the sixth passageway having a distal end, wherein the distal end of the sixth passageway is proximate the discharge port such that the dispensing fluid carried by the sixth passageway exits the distal end of the fourth passageway proximate the discharge port.

19. The fluid dispenser of claim 18, wherein the first, third, and fifth passageways are substantially parallel to an axis of the valving rod, wherein the first, third, and fifth passageways are substantially equidistant from an axis of the valving rod, and wherein the first, third, and fifth passageways are substantially equidistant from each other.

20. The fluid dispenser of claim 18, wherein:
the housing includes a discharge end, a closed end opposite the discharge end, and at least one side extending from the discharge end to the closed end;
each of the first, third, and fifth passageways is a bore extending from the closed end that is closed at the closed end of the housing;
each of the second, fourth, and sixth passageways is a bore extending from one of the side or a protrusion extending from the side;
the bore of the first passageway and the bore of the second passageway are arranged such that an axis of the bore of the first passageway and an axis of the bore of the second passageway intersect each other and are not parallel to each other;
the bore of the third passageway and the bore of the fourth passageway are arranged such that an axis of the bore of the third passageway and an axis of the bore of the fourth passageway intersect each other and are not parallel to each other;
the bore of the fifth passageway and the bore of the sixth passageway are arranged such that an axis of the bore of the fifth passageway and an axis of the bore of the sixth passageway intersect each other and are not parallel to each other; and
the fluid dispenser further includes a first plug positioned to close the bore of the second passageway at the one of the side or the protrusion extending from the side, a second plug positioned to close the bore of the fourth passageway at the one of the side or the protrusion extending from the side, and a third plug positioned to close the bore of the sixth passageway at the one of the side or the protrusion extending from the side.

21. The fluid dispenser of claim 1, wherein an end of the housing that includes the discharge port has a generally convex or conical shape around the discharge port.

22. The fluid dispenser of claim 1, wherein the second passageway extends completely from a side of the housing to the distal end of the second passageway, and wherein the fluid dispenser further comprises:
a plug configured to seal the side of the housing from which the second passageway extends.

23. The fluid dispenser of claim 22, wherein the plug includes a ring extending around an exterior of the housing.
